(19) United States
(12) Patent Application Publication
(10) Pub. No.: US 2007/0186482 A1
(43) Pub. Date: Aug. 16, 2007

(54) Non-woven fabric abrasive material

(75) Inventor: Yasuo Sudo, Tokyo (JP)

Correspondence Address: 3M INNOVATIVE PROPERTIES COMPANY, PO BOX 33427, ST. PAUL, MN, 55133-3427, US

(73) Assignee: 3M INNOVATIVE PROPERTIES COMPANY, ST. PAUL, MINNESOTA (US)

(21) Appl. No.: 11/568,870

(22) PCT Filed: Apr. 12, 2005
(86) PCT No.: PCT/US05/12324

§ 371 Date: Nov. 9, 2006

(30) Foreign Application Priority Data
May 10, 2004 (JP) 2004-139528

(51) Int. Cl. C09K 3/14; B24D 11/00; B24D 18/00; B32B 27/04; D04H 13/00

(52) U.S. Cl. 51/295; 51/307; 51/293; 51/297; 51/308; 51/309; 442/149; 442/327

(57) ABSTRACT

A substantially lofty non-woven fabric abrasive material includes: a non-woven fabric composed of randomly arrayed fibers; an adhesive agent adhered to the fibers of the non-woven fabric; and abrasive particles adhered to the non-woven fabric by the adhesive agent; wherein the abrasive particles contain soft large-sized particles and hard small-sized particles.

### BACKGROUND

The present invention relates to a non-woven fabric abrasive material, and particularly a non-woven fabric abrasive material for removing fouling, scorching and clouding which adhere to materials such as metal, plastics and glass.

A non-woven fabric abrasive material has been widely known which comprises a substrate such as a non-woven fabric, an adhesive agent provided on a surface of the substrate and abrasive particles provided on the surface of the substrate, at least a part of which is buried in the adhesive agent. For example, an abrasive pad composed of a non-woven fabric abrasive material with a low density is frequently used for polishing pots and pans also in ordinary households.

Among such pads, a commercial product bringing a greatly favorable result includes a commercial product under the trade name of Scotch Brite manufactured by 3M Company. Typically, such an abrasive pad can be manufactured by a method disclosed in U.S. Pat. No. 2,958,593 (Hoover et al.).

With regard to these abrasive pads, two kinds of an abrasive pad with an abrasive agent and an abrasive pad without an abrasive agent are generally put on the market, and alternatively a type such that this pad and a sponge of urethane or cellulose are stuck together is also put on the market. A pad with an abrasive agent is used for polishing ceramic tableware and cooking utensils and the bottom of pans, while a pad without an abrasive agent or a sponge surface of a pad of a sticking type is used for polishing unscorched metal surfaces and plastic tableware and cooking utensils.

This results from the usefulness of an abrasive pad with an abrasive agent for removing various kinds of fouling such as tea incrustations and yellowing which adhere to ceramics, other general fouling and scorching of pans, while the abrasive pad with an abrasive agent leaves a scar on the surface of soft materials such as metal, glass and plastic. A conventional abrasive pad, therefore, insufficiently removes fouling and seriously scratches the surface of materials to be polished if the proper use thereof is wrong or the presence of an abrasive agent is mistaken.

This is also the case for the abrasive materials which have various abrasive particles, that is, a soft abrasive agent, a hard abrasive agent or a mixture thereof, which are adhered to fibers of the non-woven fabric, as described in Japanese Patent Laid-open Publication No. H3(1991)-14666, and damaging a surface of soft materials is not able to sufficiently be prevented with using the above described abrasive particles.

So damaging with abrasive materials of materials to be abraded, may be prevented as abrasive particles having small particle size are employed. Abrasive particles having small particle size are actually employed for lapping.

However, such an abrasive pad is poor in abrasive power, which is not effective for polishing ceramics and the bottom of pans and removing hard fouling. Also, Japanese Patent Laid-open Publication No. S62(1987)-88569 discloses that an abrasive pad containing abrasive particles in a range of 12 H.K. to 60 H.K. in Knoop hardness (polymer particles such as polyester, polymethacrylate, polycarbonate and polystyrene) allows scorching to be removed without scratching cooking utensils. This abrasive pad, however, has an insufficient abrasive power and thereby does not allow hard and thin film-like fouling to be removed, such as dull fouling of metallic parts and tea incrustations adhering to ceramics, among fouling in cookery and of cooking utensils.

An attempt to manufacture a pad having a surface of an abrasive and a surface for burnishing has been also made in U.S. Pat. No. 3171151, which requires precise manufacturing processes and does not obtain a bulky abrasive pad.

### SUMMARY

The present invention overcomes the above-mentioned shortcomings by providing a substantially lofty non-woven fabric abrasive material which conveniently and effectively removes soft and hard fouling stuck to materials to be abraded, without damaging the materials to be abraded.

The present invention provides a non-woven fabric abrasive material comprising a non-woven fabric composed of randomly arrayed fibers; an adhesive agent adhered to the fibers of the non-woven fabric; and abrasive particles adhered to the non-woven fabric by the adhesive agent, in which the abrasive particles contain soft large-sized particles and hard small-sized particles, whereby the above-mentioned object is attained.

Two kinds of abrasive particles having different particle diameters can properly contact with a surface to be polished without hiding each other by the elasticity of a non-woven fabric (spring effect), whereby performing the abrasive power characteristic of each of the abrasive particles. Consequently, this pad has a low possibility of scratching a surface in polishing cookery, cooking utensils and tableware to be washed, and also one pad can remove scorching of pots and pans, dull fouling of metallic and glasses, tea incrustations and the like. Further, an effect of polishing metal parts is obtained with the abrasive particles being controlled in a certain range.

### DETAILED DESCRIPTION

A non-woven fabric employed in the present invention is a lofty open-structured sheet material made of randomly arrayed fibers. A bulky open-structured sheet material is abundant in elasticity, and two kinds of abrasive particles having different particle diameters can properly contact with a surface to be polished by spring effect. It is preferred that a non-woven fabric is a material well known as a substrate of a non-woven fabric abrasive material to those skilled in the art. A typical non-woven fabric is described, for example, on Japanese Patent Laid-Open Publication No. H2(1990)-124272.

A preferable non-woven fabric is composed of a thermoplastic organic fiber such as polyamide (such as nylon 6 and nylon 6.6 composed of polycaprolactam and polyhexamethyladipamide), polyolefin (such as polypropylene and polyethylene), polyester (such as polyethylene terephthalate) and polycarbonate. A non-woven fabric composed of nylon and polyester fibers is generally used.

The thickness of a fiber is generally approximately 19 to 250 μm in diameter. The thickness of a non-woven fabric is generally approximately 2 to 50 mm. Arrayed fibers have crossings and contact points mutually bonded by frictional force, adhesive agent force and the like. The adhesion of fibers may be performed by the melting of the fibers themselves or the use of an adhesive agent.

An adhesive agent is used for bonding fibers of a non-woven fabric or fibers of a non-woven fabric with abrasive particles. An adhesive agent for bonding fibers of a non-woven fabric may be different from, or same as an abrasive agent for bonding fibers of a non-woven fabric with abrasive particles. In the case when the same abrasive agent is employed, bonding fibers of a non-woven fabric and bonding fibers of a non-woven fabric with abrasive particles may be conducted at the same time in production method.

In general, an adhesive agent contains a binder resin and an additive as a component. A binder resin means an organic resin offering the function of bonding a substance by the change of a coatable liquid to a stiff solid. Also, an adhesive agent precursor particularly means an adhesive agent in a liquid state.

An adhesive agent used for bonding fibers of a non-woven fabric can involve a thermosetting adhesive agent such as an aqueous suspension and an organic solvent solution of epoxy, melamine, phenol, isocyanate and isocyanurate resins, or a rubber-based polymer solution or suspension such as SBR, SBS and SIS. These adhesive agents are used for being applied to fibers by an immersion coating method, a roll coating method, a spray coating method and the like so as to be thermoset.

Abrasive particles employed in the present invention are a mixture of soft particles and hard particles. Soft particles have a Mohs hardness within a range of 1 to 7, preferably 2 to 4. A Mohs hardness of less than 1 in soft particles brings an insufficient abrasive power to an abrasive pad, while a Mohs hardness of more than 7 therein brings the possibility of scratching a surface to be polished. The material of soft particles is an inorganic material such as garnet, flint, silica, pumice stone and calcium carbonate, an organic polymer material such as polyester, polyvinyl chloride, methacrylate, methyl methacrylate, polycarbonate and polystyrene, and the like.

Soft particles are required to have a large size as compared with hard particles. For example, the particle diameter of soft large-sized particles is 10 to 1000 times, preferably 30 to 100 times the particle diameter of hard small-sized particles. If the particle diameter of soft large-sized particles is less than 10 times the particle diameter of hard small-sized particles, then the abrasive power of an abrasive pad is rendered insufficient and a surface to be polished is scratched.

Specifically, the average particle diameter of soft large-sized particles is 0.1 to 1 mm, preferably 0.1 to 0.3 mm. For example, the particles of No. 20 to 120, preferably No. 20 to 54 in Japanese Industrial Standard (JIS) R6001 are included in this range. An average particle diameter of less than 0.1 mm in soft large-sized particles brings difficulty in removing thick fouling such as scorching, while an average particle diameter of more than 1 mm therein brings difficulty in holding themselves properly.

Hard particles have a Mohs hardness within a range of 8 or more, preferably 8 to 9. A Mohs hardness of less than 8 in hard particles brings a weak function of removing hard and thin film-like fouling such as dull fouling of metallic parts and tea incrustations adhering to ceramics. The material of hard particles is silicon carbide, aluminum oxide, topaz, fusion alumina-zirconia, boron nitride, tungsten carbide, silicon nitride and the like.

The average particle diameter of hard small-sized particles is 1 to 10 μm, preferably 3 to 7 μm. For example, the particles of No. 1000 to 8000, preferably No.3000 to 6000 in JIS R6001 are included in this range. An average particle diameter of less than 1 μm in hard small-sized particles brings substantially impossible in removing hard and thin film-like fouling, while an average particle diameter of more than 10 μm therein brings large level in scratching.

Combination ratio of the soft large-sized particles and the hard small-sized particles is useful in the range of from 1:9 to 9:1. If the soft large-sized particles is larger in quantity than the range, it becomes difficult to remove hard and thin film-like fouling such as dull fouling of metal, whereas if the hard small-sized particles is larger in quantity than the range, it becomes difficult to remove soft and thick fouling such as food scorch fouling. More preferred combination range is that the soft large-sized particles are larger in quantity than a combination ratio of 2:8 in order to keep advantage due to the soft large-sized particles and the hard small-sized particles as long as possible, whereas the soft large-sized particles are smaller in quantity than a ratio of 7:3 from the view of a coating process as too large quantity of soft large-sized particles decreases flowing ability of a combined liquid.

An adhesive agent for bonding fibers of a non-woven fabric and abrasive particles may be aqueous or solvent-based. An adhesive agent after being thermoset preferably denotes substantially the same hardness as soft large-sized particles. If the hardness of an adhesive agent is substantially lower than that of soft large-sized particles, then the adhesive agent covers up the soft large-sized particles, and abrasive power becomes poor. If the hardness of an adhesive agent is substantially higher than that of soft large-sized particles, then a surface to be polished is possibly scratched. A binder resin of an adhesive agent to be used can involve epoxy, melamine, phenol, isocyanate and isocyanurate resins, and the like. A particularly preferably binder resin is a phenol resin, an epoxy resin and the like.

A non-woven fabric abrasive material of the present invention can be produced in accordance with a method known to those skilled in the art. For example, abrasive particles are first added to an adhesive agent precursor and dispersed thereinto with a sufficient uniformity so as to obtain a dispersion solution. The dispersion solution is applied on the surface of fibers of a non-woven fabric. It is preferred that an applying method to be used is an immersion coating method, a roll coating method, a spray coating method and the like.

Soft large-sized particles and hard small-sized particles may be projected into the same adhesive agent precursor and concurrently applied, or projected into different adhesive agent precursors and separately applied. Also, an adhesive agent precursor is previously applied to a non-woven fabric, and then abrasive particles may be sprayed thereon.

In the case of using a thermosetting resin as a binder resin, the adhesive agent precursor is thereafter thermoset by heating for a certain time. In general, an adhesive agent precursor is thermoset by maintaining at a temperature of 100 to 300° C. for 10 to 30 minutes.

The present invention is further detailed by the following examples, and is not limited thereto. The denotation of quantity means ‘part by weight’ unless otherwise specified in the examples.

### EXAMPLES

### Examples 1 to 7, Comparative Examples 1 to 4

A non-woven web having a substantial thickness of approximately 1 cm and a basic weight of approximately 122 g/m² was formed by a landau weaver machine from a crimped and aligned nylon 6,6 fiber having a length of 4 cm (when extended) and a value of 15 d (a diameter of 40 μ). An adhesive agent precursor was prepared by mixing the following components.

TABLE 1

| Components | Mixed Quantity |
|---|---|
| NCO-terminated Urethane Prepolymer | 40 |
| “TAKENATE A3” manufactured by Takeda | |
| Seiyaku Kogyo K. K. | |
| Dibasic Acid-based Polyester Polyol | 30 |
| “ADEKA NEW ACE” manufactured by Asahi | |
| Denka Kogyo K. K. | |
| Propylene Glycol Monomethyl Ether Acetate | 30 |
| “PGM-AC” manufactured by Kuraray K. K. | |
| Dibutyl tin dilaurate | 0.008 |
| “ADEKA STAB BT-11” manufactured by | |
| Asahi Denka Kogyo K. K. | |

The above-mentioned adhesive agent precursor was applied to the above-mentioned non-woven web having a substantial thickness, which was being passed between two rubber rolls. The dry application weight thereof was 200 g/m². The non-woven web to which the adhesive agent precursor was applied was heated at a temperature of 150° C. for 10 minutes and cured to obtain a non-woven fabric having a thickness of 6 mm.

A dispersion solution composed as shown in the following Tables 2 and 3 was prepared so as to spray-coat the non-woven fabric therewith. The dry application weight of the adhesive agent was made into 1.1 g/100 cm². Thereafter, the non-woven fabric to which the dispersion solution was applied was heated for 15 minutes at a drying temperature shown in Tables 2 and 3 to obtain a non-woven fabric abrasive material. This non-woven fabric abrasive material was cut out into 7.5 cm width x 11 cm length to obtain an abrasive pad.

TABLE 2

| | Examples | | | | | | |
|---|---|---|---|---|---|---|---|
| | 1 | 2 | 3 | 4 | 5 | 6 | 7 |
| Phenol Resin Prepolymer | 50 | 50 | 50 | 50 | 50 | 50 | 50 |
| (77%-aqueous solution)^{a} | | | | | | | |
| Aqueous Urethane Resin^{b} | | | | | | | |
| SBR Emulsion^{c} | | | | | | | |
| Water | 5 | 22 | 16 | 12 | 17 | 17 | 17 |
| Isopropanol | 5 | 22 | 16 | 12 | 17 | 17 | 17 |
| Aerosol 0T^{d} | | | | | | | |
| Polyvinyl Chloride | | | | | 50 | 50 | 50 |
| Particles (147μ on | | | | | | | |
| average) | | | | | | | |
| Nylon 6 Particles (239μ on | 20 | 40 | 25 | 10 | | | |
| average) | | | | | | | |
| Alumina Particles (count | | | | | 12.5 | | |
| No. 2000) | | | | | | | |
| Alumina Particles (count | 5 | 10 | 25 | 40 | | 12.5 | |
| No. 4000) | | | | | | | |
| Alumina Particles (count | | | | | | | 12.5 |
| No. 6000) | | | | | | | |
| Alumina Particles (count | | | | | | | |
| No. 320) | | | | | | | |
| Drying Temperature | 150° C. | 150° C. | 150° C. | 150° C. | 150° C. | 150° C. | 150° C. |

^{a}“PHENOLITE GA 1364” manufactured by Dainippon Inki Kagaku Kogyo K.K
^{b}“BONTITER HUX 811” manufactured by Adeka K.K.
^{c}“0619 SBR LATEX” manufactured by JSR K.K.
^{d}“AEROSOL OT-75” manufactured by Kao K.K.

TABLE 3

| | Comparative Examples | | | |
|---|---|---|---|---|
| | 1 | 2 | 3 | 4 |
| Phenol Resin Prepolymer (77%-aqueous solution)^{a} | | | | 50 |
| Aqueous Urethane Resin^{b} | 50 | | | |
| SBR Emulsion^{c} | | 50 | 50 | |
| Water | | 30 | 30 | 22 |
| Isopropanol | | | | 22 |
| Aerosol 0T^{d} | 2 | 2 | 2 | 2 |
| Polyvinyl Chloride Particles (147μ on average) | | | | |
| Nylon 6 Particles (239μ on average) | 40 | 40 | 40 | |
| Alumina Particles (count No. 2000) | | | 10 | |
| Alumina Particles (count No. 4000) | 10 | 10 | | |
| Alumina Particles (count No. 6000) | | | | |
| Alumina Particles (count No. 320) | | | | 50 |
| Drying Temperature | 100° C. | 100° C. | 100° C. | 100° C. |

^{a}“PHENOLITE GA 1364” manufactured by Dainippon Inki Kagaku Kogyo K.K
^{b}“BONTITER HUX 811” manufactured by Adeka K.K.
^{c}“0619 SBR LATEX” manufactured by JSR K.K.
^{d}“AEROSOL OT-75” manufactured by Kao K.K.

The detergency of the obtained abrasive pad was evaluated by the following tests.

1) Scorch Fouling Removal Test (Food Soil Removal Test)

TABLE 4

| Employed Materials | Quantity | |
|---|---|---|
| 100% beef minced meat | 120 | g |
| CHEDER CHEESE manufactured by Craft Co. | 60 | g |
| MEIJI 3.5 MILK | 120 | g |
| granulated sugar manufactured by Nissin Seito K. K. | 100 | g |
| OREGON CHERRY JUICE (12 cherries, including | 120 | g |
| solid) | | |
| egg (size M) | 1 | |
| wheat flour | 20 | g |
| KAGOME TOMATO JUICE (concentrated and | 120 | g |
| reduced) | | |

The materials of the quantity as shown in Table 4 was prepared. The beef minced meat and the cheese were mixed in a blender, the cherry juice and the tomato juice were added to this and again mixed in the blender. Further the milk, the granulated sugar, and the wheat flour were added to this and mixed in the blender. 2 g of the resulting mixture was coated uniformly on a stainless plate (SUS 304, 50 ×28 mm). This was put in an oven of 180° C., and baked for 30 minutes, repeatedly in three times. An abrasive pad was applied to a surface of the stainless plate to which food soil adhered as described above, and then the surface was rubbed with the pressure of a thumb. It was evaluated how easily the food soil was removed.

Evaluating Standards

Removed: ◯
Not removed: ×
   2) Stainless Dull Fouling (Surface Oxide) Removal Test

Salad oil was applied to a stainless steel plate, which was heated by a gas ring to form light-brown dull fouling. A non-woven fabric abrasive material was applied to the dull surface, which was rubbed with a hand. It was evaluated how easily the dull fouling was removed.

Evaluating Standards

Particularly quickly removed: ⊚
Removed: ◯
Time-consumingly removed: Δ
Not removed: ×
   3) Friction Test

An abrasive pad was applied to the surface of a stainless steel plate, a lunch box made of melamine, and a glass plate which was rubbed with a hand for 10 roundtrips. It was visually evaluated how seriously the rubbed surface was scratched.

Evaluating Standards

Not observed even with stare: ⊚
Visually observed with difficulty: ◯
Visually observed: Δ

Gloss lost: ×Results are shown in Table 5.

TABLE 5

| | | Examples | | | | | | | C. Ex. | | | |
|---|---|---|---|---|---|---|---|---|---|---|---|---|
| | | 1 | 2 | 3 | 4 | 5 | 6 | 7 | 1 | 2 | 3 | 4 |
| Scorch Fouling | | ∘ | ∘ | ∘ | ∘ | ∘ | ∘ | ∘ | x | x | x | ∘ |
| Removal Test | | | | | | | | | | | | |
| Dull Fouling | | Δ | ∘ | ∘ | ⊚ | ∘ | ∘ | x | ∘ | ∘ | ∘ | ⊚ |
| Removal Test | | | | | | | | | | | | |
| Fric- | Scratching | ∘ | ∘ | ∘ | ∘ | Δ | ∘ | ⊚ | ∘ | ∘ | Δ | x |
| tion | object: | | | | | | | | | | | |
| Test | Stainless | | | | | | | | | | | |
| | Scratching | ⊚ | ⊚ | ⊚ | ⊚ | Δ | ⊚ | ⊚ | ⊚ | ⊚ | Δ | x |
| | object: | | | | | | | | | | | |
| | Melamine | | | | | | | | | | | |
| | Scratching | ⊚ | ⊚ | ⊚ | ⊚ | Δ | ⊚ | ⊚ | ⊚ | ⊚ | Δ | x |
| | object: | | | | | | | | | | | |
| | Glass | | | | | | | | | | | |

Through the Examples 1 to 7, and the Comparative Examples 1 to 4, a binder having a Mohs hardness of less than 2, here, an SBR resin and an urethane resin are not appropriate in view of the removal of food soil, while a phenol resin, an epoxy resin and the like having a Mohs hardness of more than 2 are appropriate. Also, with regard to the size of a particulate abrasive, an abrasive having a size of No. JIS 2000 or smaller offers a degree of less scratching, while an abrasive having a smaller size than No. JIS 6000 finds difficulty in removing dull fouling. Accordingly, an preferable size of particulate abrasives is No. JIS 2000 to 6000.

### Examples 8 to 16, Comparative Example 5

A non-woven web having a substantial thickness of approximately 1 cm and a basic weight of approximately 122 g/m² was formed by a landau weaver machine from a crimped and aligned nylon fiber having a length of 4 cm (when extended) and a value of 15 d (a diameter of 40 μ). An adhesive agent mixture was prepared by mixing 97 parts of “0619 SBR LATEX” manufactured by JSR K.K. and 3 parts of “AEROSOL OT-75” manufactured by Kao K.K.

The above-mentioned adhesive agent mixture was applied to the above-mentioned non-woven web having a substantial thickness, which was being passed between two rubber rolls. The dry application weight thereof was 100 g/m². Onto the non-woven web to which the adhesive agent precursor was applied, and in which the fibers were fixed, a mixture of the following formulation was applied with a spray gun.

TABLE 6

| | Examples | | | | | | | | | C. Ex. |
|---|---|---|---|---|---|---|---|---|---|---|
| | 8 | 9 | 10 | 11 | 12 | 13 | 14 | 15 | 16 | 5 |
| Phenol | 50 | 50 | 50 | 50 | 50 | 50 | 50 | 100 | 100 | 50 |
| Resin | | | | | | | | | | |
| Prepolymer | | | | | | | | | | |
| (77%-aq. | | | | | | | | | | |
| solution)^{a} | | | | | | | | | | |
| Hydroxypropyl | 5 | 5 | 5 | 5 | 5 | 5 | 5 | 10 | 10 | 5 |
| methyl | | | | | | | | | | |
| cellulose, | | | | | | | | | | |
| Cellulose | | | | | | | | | | |
| ether thickner | | | | | | | | | | |
| (1.5% IPA, | | | | | | | | | | |
| Water)^{b} | | | | | | | | | | |
| Water | 17.5 | 17.5 | 17.5 | 17.5 | 17.5 | 17.5 | 17.5 | 39 | 60 | 17.5 |
| Isopropanol | 17.5 | 17.5 | 17.5 | 17.5 | 17.5 | 17.5 | 17.5 | 39 | 60 | 17.5 |
| Nylon 6 | 25 | 20 | 20 | 25 | 20 | 25 | 20 | 10 | 90 | 25 |
| Particles | | | | | | | | | | |
| (239μ on | | | | | | | | | | |
| average) | | | | | | | | | | |
| Alumina | | | | | | 25 | 30 | | | |
| Particles | | | | | | | | | | |
| (No. 2000) | | | | | | | | | | |
| Alumina | | | | 25 | 30 | | | 90 | 10 | |
| Particles | | | | | | | | | | |
| (No. 4000) | | | | | | | | | | |
| Alumina | | | 30 | | | | | | | |
| Particles | | | | | | | | | | |
| (No. 6000) | | | | | | | | | | |
| Alumina- | 25 | 30 | | | | | | | | |
| zircon mixed | | | | | | | | | | |
| abrasives | | | | | | | | | | |
| (3.3-4.1 | | | | | | | | | | |
| micron ave. | | | | | | | | | | |
| particle size) | | | | | | | | | | |
| Coating | 1.6 | 1.9 | 1.6 | 1.6 | 1.8 | 1.6 | 1.6 | 1.7 | 1.7 | 1.9 |
| Amount | | | | | | | | | | |
| (after | | | | | | | | | | |
| drying) | | | | | | | | | | |
| Drying | 150° C. | 150° C. | 150° C. | 150° C. | 150° C. | 150° C. | 150° C. | 150° C. | 150° C. | 150° C. |
| Temperature | | | | | | | | | | |

^{a}“PHENOLITE GA 1364” manufactured by Dainippon Inki Kagaku Kogyo K.K
^{b}“METOLOSE 65 SH-4000” manufactured by Shin Etsu Kagaku Kogyo K.K.
^{c}“FO 3000” manufactured by Fujimi Incorporated.

The detergency of the resulting abrasive pad was evaluated by the following tests. The results are shown in Table 7.

1) Scorch Fouling Removal Test (Food Soil Removal Test)

A stainless plate with scorch fouling same as that employed in Examples 1 to 7 was prepared. The abrasive pad was allowed to move go and back with a valid pad area of 49.59 cm² (5.7 cm ×8.7 cm), a pressure of 48.09 g/cm², a speed of 45 roundtrip/min and a stroke of 35 cm to rub the stainless plate with scorch fouling having a default area of 114 cm² (5.0 cm ×22.8 cm). In every 20 times go and back, deterged area was calculated in an area of 36.1.cm² (19 cm ×1.9 cm)which was located at the middle of the plate. This was repeated until 90% of the area was deterged, and times required for 100% detergency was calculated with being approximation to secondary curve on the least-squares method. Shown is a converted value based on the calculated times as a value for Comparative Example 1 (no particulate abrasives) is assumed to be 100.

2) Stainless Dull Fouling (Surface Oxide) Removal Test

A stainless steel plate was uniformly rubbed with “SCOTCH BRITE A 11” manufactured by Sumitomo 3M to make the surface to have a gloss (20 degree gloss) of 20 to 40. “Micro-Tri Gloss Meter” manufactured by BYK-Gardner Corporation was employed for the gloss measurement. The stainless plate was burned with a gas range to put burned color as the “dull fouling”. It was confirmed that the surface had a 20 degree gloss of not more than about 25. With using “PUSH PULL TESTER” manufactured by Toyo Seiki K.K., the stainless plate was rubbed at a speed of 45, for ten times go and back, at abrasive angles of −35, 0, and +35 degrees. In every unit of repetition (every 30 times), 20 degree gloss was measured. A Gloss value resulted from 150 times abrasion was calculated with being approximation to secondary curve on the least-squares method, and shown.

3) Glass Friction Test

An abrasive pad was applied to the surface of a glass plate, which was rubbed with a hand for 10 times go and back. It was evaluated under the following standards how seriously the rubbed surface was scratched.

Evaluating Standards

Not observed with naked eye nor with microscope (150 powered): ◯
Not observed with naked eye but observed with microscope (150 powered): Δ

Observed with naked eye: ×

TABLE 7

| | Examples | | | | | | | | | C. Ex. |
|---|---|---|---|---|---|---|---|---|---|---|
| | 8 | 9 | 10 | 11 | 12 | 13 | 14 | 15 | 16 | 5 |
| Scorch | 58 | 90 | 86 | 79 | 94 | 99 | 88 | 90 | 99 | 100 |
| Fouling | | | | | | | | | | |
| Removal | | | | | | | | | | |
| Test | | | | | | | | | | |
| Dull | 256 | 346 | 242 | 241 | 252 | 320 | 342 | 288 | 92 | 1 |
| Fouling | | | | | | | | | | |
| Removal | | | | | | | | | | |
| Test | | | | | | | | | | |
| Friction Test | Δ | Δ | ∘ | ∘ | ∘ | Δ | Δ | ∘ | ∘ | |
| Scratching | | | | | | | | | | |
| object: Glass | | | | | | | | | | |

Through the Examples 11, 12, 15, 16, and the Comparative Example 1, the mixing ratio of particulate abrasives and soft particulate abrasives is effective in the range of 1:9 to 9:1 for removing the scorch fouling and the dull fouling.

Through the Examples 16, 13, 14, 15, and Comparative Example 5, scratches resulted from the particulate abrasives having a size of No. 2000 to 3000 have a fineness which is close to visible limitations, and they are substantially invisible. When the size is not less than No. 4000, the resulting scratches become below the optically visible limitations, and scratches substantially are not formed. That is, the particulate abrasives having a size of not more than No. 2000 are effective from the view of scratching property, whereas the larger size, that is No. 2000 is more effective than No. 4000, or than No. 6000, from the view of removing dull fouling and of improving gloss.

As a whole of the above, the preferred range of the particulate abrasive size is from No. 3000 to No. 6000. The particulate abrasives employed in Examples 8 and 9 are based on zirconia-containing alumina, and substantially the same performance were obtained.

### Examples 17 to 25

Influence of Coating Amount

A non-woven web having a substantial thickness of approximately 1 cm and a basic weight of approximately 122 g/m² was formed by a landau weaver machine from a crimped and aligned nylon fiber having a length of 4 cm (when extended) and a value of 15 d (a diameter of 40 μ). An adhesive agent mixture was prepared by mixing 97 parts of “0619 SBR LATEX” manufactured by JSR K.K. and 3 parts of “AEROSOL OT-75” manufactured by Kao K.K.

The above-mentioned adhesive agent mixture was applied to the above-mentioned non-woven web having a substantial thickness, which was being passed between two rubber rolls. The dry application weight thereof was 100 g/m². Onto the non-woven web to which the adhesive agent precursor was applied, and in which the fibers were fixed, a mixture of the following formulation was applied with a spray gun.

TABLE 8

| | Examples | | | | | | | | |
|---|---|---|---|---|---|---|---|---|---|
| | 17 | 18 | 19 | 20 | 21 | 22 | 23 | 24 | 25 |
| Phenol | 37 | 37 | 37 | 37 | 37 | 37 | 39.2 | 39.2 | 39.2 |
| Resin | | | | | | | | | |
| Prepolymer | | | | | | | | | |
| (77%-aq. | | | | | | | | | |
| solution)^{a} | | | | | | | | | |
| Water | 7 | 7 | 7 | 7 | 7 | 7 | 7.8 | 7.8 | 7.8 |
| Isopropanol | 9.3 | 9.3 | 9.3 | 9.3 | 9.3 | 9.3 | 10 | 10 | 10 |
| Nylon 6 | 18.7 | 18.7 | 18.7 | 18.7 | 18.7 | 18.7 | 19.8 | 19.8 | 19.8 |
| Particles | | | | | | | | | |
| (239μ on | | | | | | | | | |
| average) | | | | | | | | | |
| Alumina | 28 | 28 | 28 | | | | 19.8 | 19.8 | 19.8 |
| Particles | | | | | | | | | |
| (No. 4000) | | | | | | | | | |
| Alumina | | | | 28 | 28 | 28 | | | |
| Particles | | | | | | | | | |
| (No. 2500) | | | | | | | | | |
| Coating | 1.1 | 1.6 | 2.3 | 1.1 | 1.6 | 2.3 | 1.1 | 1.6 | 2.3 |
| Amount | | | | | | | | | |
| (after | | | | | | | | | |
| drying) | | | | | | | | | |
| Drying | 150° C. | 150° C. | 150° C. | 150° C. | 150° C. | 150° C. | 150° C. | 150° C. | 150° C. |
| Temperature | | | | | | | | | |

^{a}“PHENOLITE GA 1364” manufactured by Dainippon Inki Kagaku Kogyo K.K

The detergency of the resulting abrasive pad was evaluated according to the same manner as described in Examples 8 to 16. The results are shown in Table 9.

TABLE 9

| | Examples | | | | | | | | | C. Ex. |
|---|---|---|---|---|---|---|---|---|---|---|
| | 17 | 18 | 19 | 20 | 21 | 22 | 23 | 24 | 25 | 4 |
| Scorch | 107 | 97 | 51 | 102 | 86 | 83 | 104 | 62 | 52 | 100 |
| Fouling | | | | | | | | | | |
| Removal | | | | | | | | | | |
| Test | | | | | | | | | | |
| Dull | 413 | 342 | 310 | 496 | 328 | 300 | 246 | 111 | 111 | 1 |
| Fouling | | | | | | | | | | |
| Removal | | | | | | | | | | |
| Test | | | | | | | | | | |
| Friction Test | ∘ | ∘ | ∘ | Δ | Δ | Δ | ∘ | ∘ | ∘ | ∘ |
| Scratching | | | | | | | | | | |
| object: Glass | | | | | | | | | | |

The performance for removing scorch fouling has a tendency to be improved in proportion to increase of the coating amount. However, in actual use, there is little difference in the performance dependent on the coating amounts as employed in the Examples, and all the amounts are within an effective range from the view of the performance.

It is preferred that the abrasive pad of the present invention is typically rectangular or circular and has a size of not more than a palm. The pad is a non-woven fabric structure having a substantial thickness made of crimped filaments of nylon or polyester having mixed denier, and contact points therein are bonded with a polymer binder. At least one surface of the non-woven fabric structure is coated with a binder which comprises at least two kinds of abrasive particles.

The pad has reduced degree of damaging metal or plastics when kitchen, cookers, or tableware is rubbed and polished for washing, and is able to make scorch of a pot or a pan, dull fouling of a metal part, tea incrustations and the like clean with one pad, in addition, to increase gloss of the metal part due to polishing effect.

1. A substantially lofty non-woven fabric abrasive material comprising:
a non-woven fabric composed of randomly arrayed fibers;
an adhesive agent adhered to the fibers of the non-woven fabric; and
abrasive particles adhered to the non-woven fabric by the adhesive agent;
wherein the abrasive particles contain soft large-sized particles and hard small-sized particles.

2. A non-woven fabric abrasive material according to claim 1, wherein a particle diameter of said soft large-sized particles is 10 to 1000 times a particle diameter of said hard small-sized particles.

3. A non-woven fabric abrasive material according to claim 1, wherein an average particle diameter of said soft large-sized particles is 0.1 to 1 mm and an average particle diameter of said hard small-sized particles is 1 to 10 μm.

4. A non-woven fabric abrasive material according to claim 1, wherein a Mohs hardness of said soft large-sized particles is 2 to 4 and a Mohs hardness of said hard small-sized particles is 8 or more.

5. A non-woven fabric abrasive material according to claim 1, wherein a Mohs hardness of said adhesive agent is the same as a Mohs hardness of said soft large-sized particles.

6. A non-woven fabric abrasive material according to claim 1, wherein combination ratio of the soft large-sized particles and the hard small-sized particles is in the range of from 1:9 to 9:1.
